(19) United States
(12) Patent Application Publication
(10) Pub. No.: US 2008/0004871 A1
(43) Pub. Date: Jan. 3, 2008

(54) Suppressing uplink noise due to channel type mismatches

(76) Inventors: Guner Arslan, Austin, TX (US); Shaojie Chen, Austin, TX (US)

Correspondence Address: NXP, B.V.;NXP INTELLECTUAL PROPERTY DEPARTMENT, M/S41-SJ, 1109 MCKAY DRIVE, SAN JOSE, CA, 95131, US

(21) Appl. No.: 11/476,972

(22) Filed: Jun. 28, 2006

(51) Int. Cl. G10L 19/12

(52) U.S. Cl. 704/221

(57) ABSTRACT

In one embodiment, the present invention includes a method for receiving a frame type indicator (FTI) associated with an encoded data portion in an encoder, receiving state information regarding a current logical channel according to a controller, and determining whether to invalidate the encoded data portion if the FTI and the state information do not indicate a channel type match. In this embodiment, only if certain types of mismatches exist between FTI and state information will the data portion be invalidated.

### FIELD OF THE INVENTION

The present invention relates to wireless technology and more particularly to speech processing in a wireless device.

### BACKGROUND

Wireless devices or mobile stations such as cellular handsets and other wireless systems transmit and receive representations of speech waveforms. A physical layer of a cellular handset typically includes circuitry for performing two major functions, namely encoding and decoding. This circuitry includes a channel codec for performing channel encoding and decoding functions and a vocoder for performing voice encoding and decoding functions. The vocoder performs source encoding and decoding on speech waveforms. Source coding removes redundancy from the waveform and reduces the bandwidth (or equivalently the bit-rate) used to transmit the waveform in real-time. The channel codec increases redundancy in the transmitted signal in a controlled fashion to enhance the robustness of the transmitted signal. Synchronizing these two functions allows the system to operate properly.

A number of different wireless protocols exist. One common protocol is referred to as global system for mobile communications (GSM). In a GSM system, the vocoder operates on blocks of speech data that are 20 milliseconds (ms) in duration. The channel codec transmits and receives data every 4.615 ms. Since the speech encoder (i.e., vocoder) serves as a data source to the channel encoder/modulator (i.e., channel codec) and the speech decoder (i.e., vocoder) serves as the data sink for the channel demodulator/decoder (i.e., channel codec), the vocoder and channel codec should be maintained in synchronization.

Adaptive multi-rate (AMR) vocoders have been introduced recently in certain cellular communication standards, such as GSM and WCDMA. AMR vocoders support multiple source rates and, compared to other vocoders, provide some technical advantages. These advantages include more effective discontinuous transmission (DTX) because of an in-band signaling mechanism, which allows for powering down of a transmitter when a user of a cellular phone is not speaking. In such manner, prolonged battery life and reduced average bit rate, leading to increased network capacity is afforded. AMR also allows for error concealment.

In a system supporting AMR, the bit rate of network communications can be controlled by the radio access network depending upon air interface loading and the quality of speech conditions. To handle such different bit rates, the network will send configuration messages to a cellular phone to control its transmission at a selected bit rate. During an AMR voice call, the network may send a message to the mobile station to change the AMR configuration (e.g., source rate).

AMR speech transmission in GSM networks is accomplished by using multiple logical channels. For example, in the AMR full-rate (AFS) case the following logical channels are used: AFS_SID_UPDATE, AFS_SID_FIRST, AFS_ONSET, AFS_SPEECH, and AFS_RATSCCH. AFS_SPEECH is the regular speech logical channel where speech data is transmitted and AFS_RATSCCH is the Robust AMR Traffic Synchronized Control Channel that is used to pass signaling associated with the AMR traffic channel. The other three logical channels are related to discontinuous transmission (DTX), and provide information regarding silence descriptors or so-called comfort noise parameters, as well as the initialization and termination of a silence mode.

When DTX is enabled, the voice encoder detects silent periods in speech and updates the DTX state machine to stop transmission. These gaps are filled with comfort noise on the other side. Since there is nothing to transmit in silence the radio transmitter can be shutdown saving precious power on the cellular phone. To make sure that the comfort noise generated on the receiving (far) end resembles the noise conditions on the near end, background noise parameters are updated periodically. Specifically, AFS_SID_UPDATE is used to send updated noise parameters, while AFS_SID_FIRST and AFS_ONSET mark the beginning and end of a period of silence, respectively.

Uplink DTX is primarily controlled by the vocoder which determines whether there is silence or speech at the microphone input. In rare cases, the vocoder and a DTX control mechanism may fall out of synchronization, with one being in a state of silence and the other being in an active speech state (or vice versa). This can have a negative impact on speech quality since the DTX control mechanism may cause the channel encoder to transmit an AFS_SID_UPDATE while the vocoder delivers regular AFS_SPEECH data to the channel encoder. Since the channel encoder has no means of verifying the data it receives, it could encode one type of data as another type, which can cause undesirable noise when played out on the receiving side.

### SUMMARY OF THE INVENTION

In one embodiment, the present invention includes a method for receiving a frame type indicator (FTI) associated with an encoded data portion in an encoder of a mobile station, receiving state information regarding a current logical channel according to a controller of the mobile station, and determining whether to invalidate the encoded data portion if the FTI and the state information do not indicate a channel type match. In some implementations, only if certain types of mismatches exist between FTI and state information will the data portion be invalidated. In this way, when a data frame to be transmitted from the mobile station is likely to cause play out of undesirable noise on a receiving end, the data frame is invalidated.

Other embodiments may be implemented in an apparatus, such as an integrated circuit (IC). The IC may include a vocoder to encode speech blocks and a channel encoder coupled to the vocoder to channel encode the encoded speech blocks. The vocoder may generate an FTI for the encoded blocks, and the channel codec can compare the FTI to information received from a controller. Based on the types of logical channel associated with the FTI and the information, the channel codec may determine whether to invalidate an encoded block. The channel codec may append an invalid error detection code to the encoded block to indicate an invalid encoded block.

Embodiments of the present invention may be implemented in appropriate hardware, firmware, and software. To that end, a method may be implemented in hardware, software and/or firmware to ensure that a channel codec and microcontroller are synchronized, and if not, take appropriate measures.

In one embodiment, a system in accordance with an embodiment of the present invention may be a wireless device such as a cellular telephone handset, personal digital assistant (PDA) or other mobile device. Such a system may include a transceiver, as well as digital circuitry. The digital circuitry may include circuitry such as an IC that includes at least some of the above-described hardware, as well as control logic to implement the above-described methods.

### BRIEF DESCRIPTION OF THE DRAWINGS

FIG. 1 is a block diagram of an audio signal processing path in a wireless device in accordance with an embodiment of the present invention.

FIG. 2A is a time division multiple access (TDMA) frame structure of a multi-slot communication standard.

FIG. 2B is a multi-frame structure used for a traffic channel of a multi-slot communication standard.

FIG. 3 is a flow diagram of a method in accordance with one embodiment of the present invention.

FIG. 4 is a flow diagram of a method of handling incoming invalid data that is generated in accordance with an embodiment of the present invention.

FIG. 5 is a block diagram of a system in accordance with one embodiment of the present invention.

### DETAILED DESCRIPTION

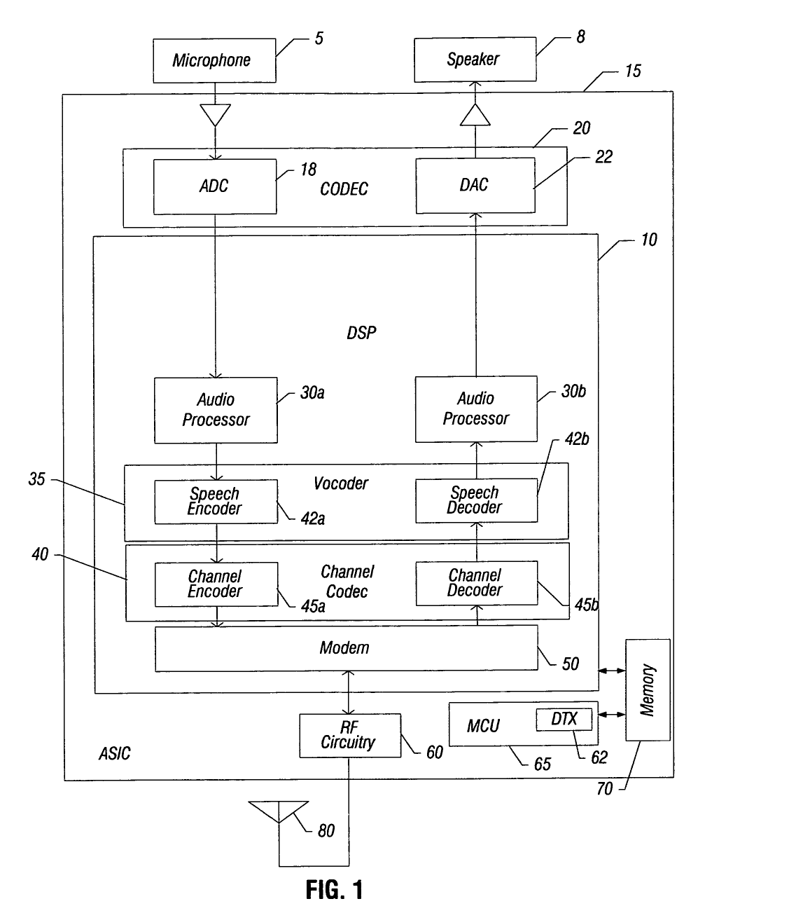

Referring to FIG. 1, shown is a block diagram of a signal processing path in a wireless device in accordance with an embodiment of the present invention. Such a transmission chain may take the form of multiple components within a cellular handset or other mobile station, for example. As shown in FIG. 1, an application specific integrated circuit (ASIC) 15 may include both baseband and radio frequency (RF) circuitry. The baseband circuitry may include a digital signal processor (DSP) 10. DSP 10 may process incoming and outgoing audio samples in accordance with various algorithms for filtering, coding, and the like.

While shown as including a number of particular components in the embodiment of FIG. 1, it is to be understood that DSP 10 may include additional components and similarly, some portions of DSP 10 shown in FIG. 1 may instead be accommodated outside of DSP 10. It is also to be understood that DSP 10 may be implemented as one or more processing units to perform the various functions shown in FIG. 1 under software control. That is, the functionality of the different components shown within DSP 10 may be performed by common hardware of the DSP according to one or more software routines. As further shown in FIG. 1, ASIC 15 may further include a microcontroller unit (MCU) 65. MCU 65 may be adapted to execute control applications and handle other functions of ASIC 15. Thus MCU 65 acts as a master device and DSP 10 as a slave device, although in many operations DSP 10 runs freely without support from MCU 65.

During transmission of speech data, MCU 65 is essentially driven by a vocoder 35. As shown in FIG. 1, MCU 65 may include a discontinuous transmission (DTX) state machine 62. DTX state machine 62 may be adapted to control discontinuous transmission operation. In such operation, DTX state machine 62 may, in an uplink direction, be primarily controlled by vocoder 35, as will be discussed further below. In some embodiments, MCU 65 may communicate with DSP 10 via a memory 70, e.g., a shared memory coupled to both components. In this way, status and control registers may be written by one or the other of MCU 65 and DSP 10 for reading by the other.

DSP 10 may be adapted to perform various signal processing functions on audio data. In an uplink direction, DSP 10 may receive incoming voice information, for example, from a microphone 5 of the handset and process the voice information for an uplink transmission. This incoming audio data may be converted from an analog signal into a digital format using a codec 20 formed of an analog-to-digital converter (ADC) 18 and a digital-to-analog converter (DAC) 22, although only ADC 18 is used in the uplink direction. In some embodiments, the analog voice information may be sampled at 8,000 samples per second or 8 kHz. The digitized sampled data may be stored in a temporary storage medium (not shown in FIG. 1). In some embodiments, one or more such buffers may be present in each of an uplink and downlink direction for temporary sample storage.

The audio samples may be collected and stored in the buffer until a complete data frame is stored. While the size of such a data frame may vary, in embodiments used in a time division multiple access (TDMA) system, a data frame (also referred to as a “speech frame”) may correspond to 20 ms of real-time speech (e.g., corresponding to 160 speech samples). In various embodiments, the input buffer may hold 20 ms or more of speech data from ADC 18. As will be described further below, an output buffer (not shown in FIG. 1) may hold 20 ms or more of speech data to be conveyed to DAC 22.

The buffered data samples may be provided to an audio processor 30a for further processing, such as equalization, volume control, fading, echo suppression, echo cancellation, noise suppression, automatic gain control (AGC), and the like. From front-end processor 30a, data is provided to vocoder 35 for encoding and compression. As shown in FIG. 1, vocoder 35 may include a speech encoder 42a in the uplink direction and a speech decoder 42b in a downlink direction. Vocoder 35 then passes the data to a channel codec 40 including a channel encoder 45a in the uplink direction and a channel decoder 45b in the downlink direction. From channel encoder 45a, data may be passed to a modem 50 for modulation. The modulated data is then provided to RF circuitry 60, which may be a transceiver including both receive and transmit functions to take the modulated baseband signals from modem 50 and convert them to a desired RF frequency (and vice versa). From there, the RF signals including the modulated data are transmitted from the handset via an antenna 80.

In the downlink direction, incoming RF signals may be received by antenna 80 and provided to RF circuitry 60 for conversion to baseband signals. The transmission chain then occurs in reverse such that the modulated baseband signals are coupled through modem 50, channel decoder 45b of codec 40, vocoder 35 (and more specifically speech decoder 42b), audio processor 30b, and DAC 22 (via a buffer, in some embodiments) to obtain analog audio data that is coupled to, for example, a speaker 8 of the handset.

Vocoder 35 and channel codec 40 may operate in a DTX mode in conjunction with DTX state machine 62. When speech encoder 42a determines that there is no incoming speech in the uplink direction, a control signal is sent to DTX state machine 62 to initiate a silent period to enable shutdown of transmission resources. DTX state machine 62 may further provide instructions to channel codec 40 for operation in DTX mode. More specifically, DTX state machine 62 may send control signals to enable channel encoder 45a to transmit various information along control logical channels such as noise parameters present at the mobile station. For example, at regular intervals in the silent period comfort noise updates, referred to as silence descriptors (SIDs) may be sent. Note that DTX state machine 62 may send information to indicate a current state of data being received by channel encoder 45a. For example, the state machine may indicate incoming data as speech data, e.g., full-rate speech or half-rate speech or instead may indicate the data as control information such as a full-rate or half-rate SID update information.

The interoperation between channel codec 40, vocoder 35, and DTX state machine 62 can occur through various mechanisms, including, for example, control signals that are provided to and from the different components. Furthermore, various status information may be provided via one or more storage locations within shared memory 70 coupled to both DSP 10 and MCU 65. As a result of these various mechanisms, it is possible that DTX state machine 62 believes it is in a silent mode of operation, while vocoder 35 believes it is in active transmission of voice information, or vice versa. When such channel types diverge, a channel type mismatch can exist between vocoder 35 and channel codec 40. Such mismatches can lead to deleterious effects, including improper coding/decoding of voice information and/or control information, either of which may create undesirable noise signatures if played out on a receiving device. As will be described further below, various mechanisms may be provided to prevent such mismatches, or to reduce their harmful effects.

For purposes of further illustration, the discussion is with respect to a representative GSM/GPRS/EDGE/TDMA system (generally a “GSM system”). However, other protocols may implement the methods and apparatus disclosed herein, particularly where different transmission modes such as a discontinuous transmission mode are possible.

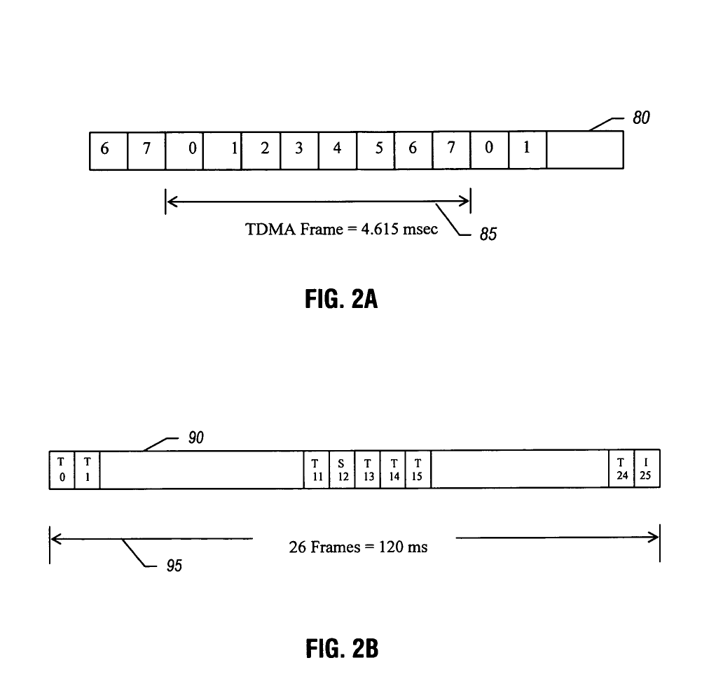

A GSM system makes use of a TDMA technique, in which each frequency channel is further subdivided into eight different time slots numbered from 0 to 7. Referring now to FIG. 2A, shown is a timing diagram of a multi-slot communication 80. As shown in FIG. 2A, multi-slot communication 80 includes a TDMA frame 85 having eight time slots in which the frequency channel of TDMA frame 85 is subdivided. Each of the eight time slots may be assigned to an individual user in a GSM system, while multiple slots can be assigned to one user in a GPRS/EDGE system. A set of eight time slots is referred to herein as a TDMA frame, and may be a length of 4.615 ms.

A 26-multiframe is used as a traffic channel frame structure for the representative system. Referring now to FIG. 2B, shown is a multiframe communication 90 that includes a 26 multi-frame formed of 26 individual TDMA frames T0-I25. As shown in FIG. 2B, the first 12 frames (T0-T11) are used to transmit traffic data. A frame (S12) is used to transmit a slow associated control channel (SACCH), which is then followed by another 12 frames of traffic data (T13-T24). The last frame (I25) stays idle. Note that the SACCH and idle frame can be swapped. The total length of a 26-frame structure is 26*4.615 ms=120 msec.

In a GSM system, a speech frame is 20 msec while a radio block is 4 TDMA frames, which is 4*4.615=18.46 msec. Data output from a speech codec is to be transmitted during the next radio block, and every three radio blocks, the TDMA frame or radio block boundary and the speech frame boundaries are aligned.

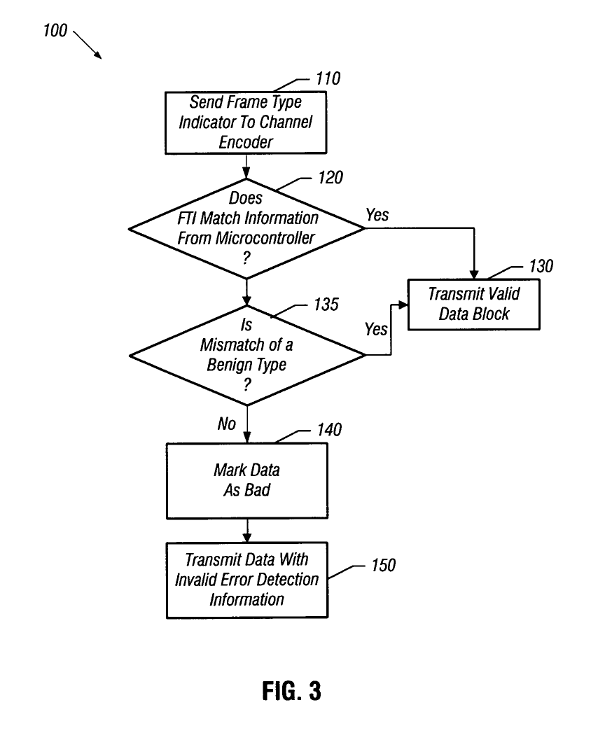

Referring now to FIG. 3, shown is a flow diagram of a method in accordance with one embodiment of the present invention. As shown in FIG. 3, method 100 may be used to determine if a channel type mismatch exists between a vocoder and a channel codec. More specifically, method 100 may be used to prevent coding and transmission of speech data as control data and vice versa. As shown in FIG. 3 method 100 may begin by sending a frame type indicator (FTI) to a channel encoder (block 110). That is, during speech encoding, e.g., by speech encoder 42a of FIG. 1, a frame type indicator may be generated to indicate whether the encoded data is speech data or control data, such as a silence noise level, e.g., SID information. This FTI may be sent with the associated encoded data from speech encoder 42a to channel encoder 45a of channel codec 40.

Still referring to FIG. 3, the channel encoder may determine whether the FTI matches information from a microcontroller (diamond 120). The information may be generated based on various sources within MCU 65, including DTX state machine 62. That is, during operation DTX state machine 62 provides instructions to control channel encoder 45a. For example, DTX state machine 62 may instruct channel encoder 45a to transmit control information, such as an updated silence noise level, e.g., an AFS_SID_UPDATE logical channel. If the information from the DTX state machine information indicates that active speech is occurring (for example), and the FTI information from the channel encoder matches, the data is thus validated, and control passes from diamond 120 to block 130. There, the channel encoder may encode the incoming speech data and transmit a valid speech block (block 130). This valid speech block may be coupled through a modem to RF circuitry of a mobile station for transmission.

If instead at diamond 120 it is determined that there is a mismatch, control passes to diamond 135. At diamond 135, it may be determined whether the mismatch is of a benign type. That is, it may be determined the type of logical channels associated with the mismatch. Some mismatch types may be benign in that the data to be transmitted is not likely to cause generation of undesired noise in a receiving device. For example, when transmitted data of a mismatch situation is received by a receiving device and processed, many mismatches may be readily detected by the receiving device such the receiving device can take appropriate measures, e.g., the playing out of comfort noise in place of the transmitted radio block. However, for other types of mismatches, the transmitted data may closely resemble speech data, although data is actually of a control nature such as a SID_UPDATE frame. Data of such mismatches is not of a benign type, as a receiving device would likely play this data out as speech data, causing undesirable noise.

Accordingly, at diamond 135 if it is determined that the mismatch is of a benign type, control passes to block 130, where a valid data block may be transmitted. Note that although the FTI of this data block does not properly match information from MCU 65, the receiving device most likely will determine that the data block is not speech data and will take appropriate measures. If instead at diamond 135, it is determined that the mismatch is not benign, control passes to block 140. In various implementations, such non-benign mismatch types may include situations where MCU 65 indicates that the data type is speech, however the FTI indicates that the data is not speech, or where MCU 65 indicates the data is update data, but the FTI indicates that the data is speech data. However, the scope of the present invention is not limited in this regard.

If it is determined that the mismatch is not of a benign type, control passes to block 140. There, the data to be encoded may be marked as bad (block 140). In different implementations, various manners of marking the encoded data as bad or invalid may be performed. For example, in one embodiment the data may be encoded normally. However, error detection information, e.g., an error detection mechanism such as a cyclic redundancy checksum (CRC) may be invalidated. The invalidated block of data is then transmitted (block 150). By causing an invalid checksum or other error detection mechanism to be invalid, the resulting transmitted information when received at a receiving location will be marked as bad data, e.g., a bad frame. Thus the receiving end does not decode the transmitted data as valid speech and play it out, which would create undesirable noise.

Note that different manners of invalidating a data block may be realized. For example, a CRC may be validly calculated, then one or more bits may be changed to ensure an invalid CRC. Alternately, a CRC may be validly calculated and then the original data may be modified to thus cause a mismatch between underlying data and the checksum. Of course, other manners of invalidating data can be realized. Further, while shown with this particular implementation in the embodiment of FIG. 3, it is to be understood that the scope of the present invention is not limited in this regard.

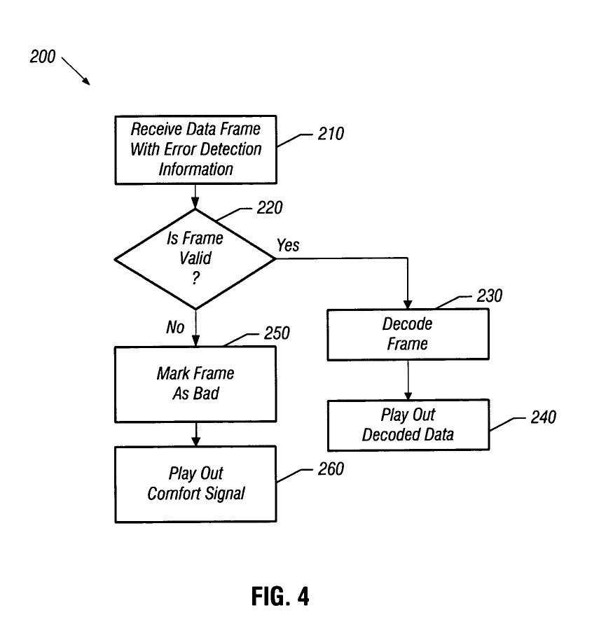

Referring now to FIG. 4, shown is a flow diagram of a method of handling incoming invalid data that is generated in accordance with an embodiment of the present invention. For example, method 200 may be used by a receiving mobile station that receives invalid data when there is a mismatch, e.g., due to a channel type mismatch between vocoder and channel encoder in the uplink direction, as described above with regard to FIG. 3.

As shown in FIG. 4, method 200 may begin by receiving a data frame with error detection information (block 210). For example, a data frame may be received in a mobile station and provided to a channel decoder that performs decoding functions, and then passes the resulting data to a speech decoder, which may perform speech decoding, as well as error detection analysis. Next, it may be determined whether the frame is valid (diamond 220). For example, the speech decoder may determine whether an error detection mechanism, e.g., a CRC appended to the data frame, is valid. If the frame is determined to be valid, for example, by verifying the checksum, control passes to block 230. There, the frame may be decoded in the speech decoder. Further audio processing on the received decoded data may be performed so that the decoded data is played out of the mobile station (block 240).

Still referring to FIG. 4, if instead at diamond 220 it is determined that the frame is not valid, control passes to block 250. There, the frame may be marked as bad, e.g., via setting of a bad frame indicator (BFI) (block 250). When a frame is marked as bad, various techniques to handle the bad frame may be performed. For example, instead of decoding the bad data, a comfort noise or other predetermined data block may be played out, to avoid undesirable noise (block 260). For example, the speech decoder may access stored comfort noise data that may be based on SID update data previously received from the transmitting mobile station.

Using embodiments of the present invention, even if synchronization between vocoder and microcontroller is lost, undesirable uplink noise may be prevented from affecting uplink audio quality. The methods described herein may be implemented in software, firmware, and/or hardware. A software implementation may include an article in the form of a machine-readable storage medium onto which there are stored instructions and data that form a software program to perform such methods. As an example, a DSP may include instructions or may be programmed with instructions stored in a storage medium to perform channel-type analysis with respect to vocoder and channel codec.

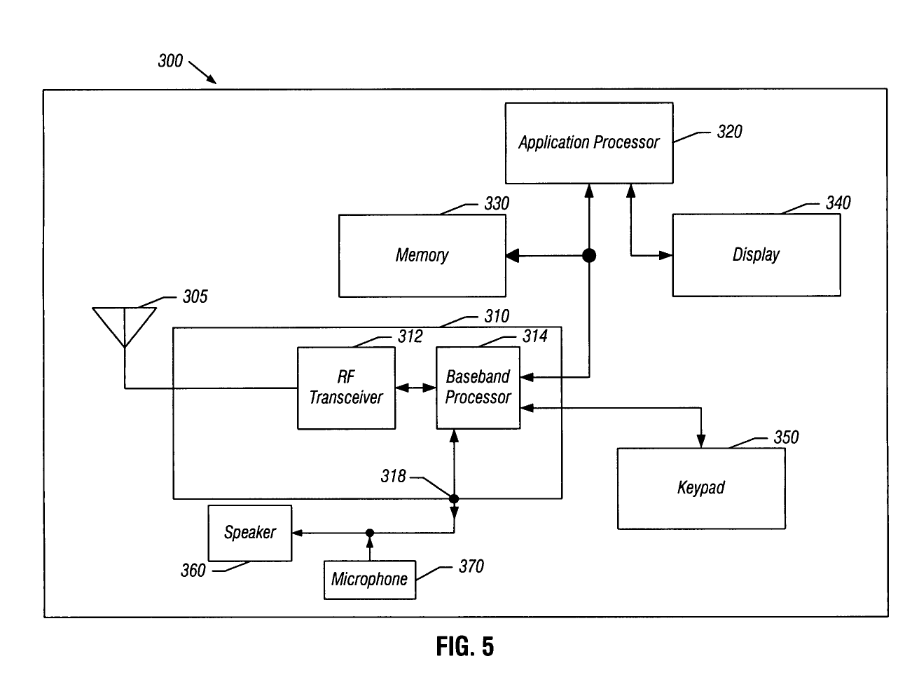

Referring now to FIG. 5, shown is a block diagram of a system in accordance with one embodiment of the present invention. As shown in FIG. 5, system 300 may be a wireless device, such as a cellular telephone, PDA, portable computer or the like. An antenna 305 is present to receive and transmit RF signals. Antenna 305 may receive different bands of incoming RF signals using an antenna switch. For example, a quad-band receiver may be adapted to receive GSM communications, enhanced GSM (EGSM), digital cellular system (DCS) and personal communication system (PCS) signals, although the scope of the present invention is not so limited. In other embodiments, antenna 305 may be adapted for use in a general packet radio service (GPRS) device, a satellite tuner, or a wireless local area network (WLAN) device, for example.

Incoming RF signals are provided to a transceiver 310 which may be a single chip transceiver including both RF components and baseband components. Transceiver 310 may be formed using a complementary metal-oxide-semiconductor (CMOS) process, in some embodiments. As shown in FIG. 5, transceiver 310 includes an RF transceiver 312 and a baseband processor 314. RF transceiver 312 may include receive and transmit portions and may be adapted to provide frequency conversion between the RF spectrum and a baseband. Baseband signals are then provided to a baseband processor 314 for further processing.

In some embodiments, transceiver 310 may correspond to ASIC 15 of FIG. 1. Baseband processor 314, which may correspond to DSP 10 of FIG. 1, may be coupled through a port 318, which in turn may be coupled to an internal speaker 360 to provide voice data to an end user. Port 318 also may be coupled to an internal microphone 370 to receive voice data from the end user.

After processing signals received from RF transceiver 312, baseband processor 314 may provide such signals to various locations within system 300 including, for example, an application processor 320 and a memory 330. Application processor 320 may be a microprocessor, such as a central processing unit (CPU) to control operation of system 300 and further handle processing of application programs, such as personal information management (PIM) programs, email programs, downloaded games, and the like. Memory 330 may include different memory components, such as a flash memory and a read only memory (ROM), although the scope of the present invention is not so limited. Additionally, a display 340 is shown coupled to application processor 320 to provide display of information associated with telephone calls and application programs, for example. Furthermore, a keypad 350 may be present in system 300 to receive user input.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a vocoder to generate an encoded audio segment and a frame type indicator (FTI) for the encoded audio segment; and
a channel codec coupled to the vocoder to further process the encoded audio segment, wherein the channel codec is to compare the FTI to information received from a controller.

2. The apparatus of claim 1, wherein the channel codec is to determine whether to invalidate the encoded audio segment based on a type of logical channel associated with each of the FTI and the information.

3. The apparatus of claim 2, wherein the channel codec is to append an invalid error detection code to the encoded audio segment to indicate the invalid encoded audio segment.

4. The apparatus of claim 2, wherein the channel codec is to indicate that the encoded audio segment is invalid if the FTI is indicative of a silence mode and the information is indicative of a speech mode.

5. The apparatus of claim 1, wherein the information from the controller comprises a data type for the encoded audio segment.

6. The apparatus of claim 1, further comprising a digital signal processor including the channel codec and the vocoder, and a microcontroller coupled to the digital signal processor, the microcontroller including the controller, wherein the controller includes a discontinuous transmission (DTX) state machine.

7. The apparatus of claim 6, wherein the microcontroller comprises a master device and the digital signal processor comprises a slave device.

8. A method comprising:
receiving a frame type indicator (FTI) associated with an encoded data portion in an encoder of a mobile station;
receiving state information regarding a current logical channel according to a controller of the mobile station; and
determining whether to invalidate the encoded data portion if the FTI and the state information do not indicate a channel type match.

9. The method of claim 8, further comprising receiving the FTI from a vocoder and receiving the state information from a microcontroller.

10. The method of claim 9, further comprising validating the encoded data portion if the FTI and the state information indicate a channel type match or if a channel type mismatch is of a benign type.

11. The method of claim 8, further comprising transmitting the invalidated encoded data portion from the mobile station.

12. The method of claim 8, further comprising:
receiving an invalid radio block in the mobile station from an uplink device; and
playing out a comfort noise from the mobile station in place of the invalid radio block.

13. The method of claim 8, further comprising invalidating the encoded data portion via modification of a checksum for the encoded data portion.

14. The method of claim 8, further comprising invalidating the encoded data portion after generation of a checksum for the encoded data portion.

15. A mobile station comprising:
an input device to receive voice information from a user;
a digital signal processor (DSP) coupled to the input device to encode the voice information or control information into an encoded radio block, wherein the DSP is to determine whether to invalidate the encoded radio block if a frame type indicator (FTI) associated with the voice information or the control information does not match state information of a controller; and
radio frequency (RF) circuitry coupled to the DSP.

16. The mobile station of claim 15, wherein the DSP and the RF circuitry are at least in part integrated within the same integrated circuit.

17. The mobile station of claim 15, wherein the DSP is to invalidate the encoded radio block by appendage of an invalid checksum onto the encoded radio block if a mismatch between the FTI and the state information is of a predetermined type.

18. The mobile station of claim 15, wherein the DSP is to invalidate the encoded radio block by modification of at least a portion of the encoded radio block after computation of a checksum for the encoded radio block if a mismatch between the FTI and the state information is of a predetermined type.

19. The mobile station of claim 15, wherein the DSP is to validate the encoded radio block if the FTI and the state information match or if a mismatch between the FTI and the state information is of a benign type.

20. The mobile station of claim 19, wherein the DSP is to generate the encoded radio block corresponding to updated noise parameters of an environment of the mobile station, under control of the controller.

21. The mobile station of claim 15, wherein the controller comprises a master device to control the DSP, the controller including a discontinuous transmission (DTX) state machine.
